(19) United States
(12) Patent Application Publication
(10) Pub. No.: US 2026/0084673 A1
(43) Pub. Date: Mar. 26, 2026

(54) Method for Operating a Control Unit for a Parking Brake System

(71) Applicant: Robert Bosch GmbH, Stuttgart (DE)

(72) Inventors: Frank Baehrle-Miller, Schoenaich (DE); Benjamin Heer, Backnang (DE)

(21) Appl. No.: 19/109,492

(22) PCT Filed: Jul. 19, 2023
(86) PCT No.: PCT/EP2023/069989

§ 371 Date: Mar. 6, 2025

(30) Foreign Application Priority Data
Sep. 12, 2022 (DE) 10 2022 209 494.8

(51) Int. Cl. B60T 13/74; B60T 17/22

(52) U.S. Cl. CPC B60T 13/741; B60T 17/221; B60T 2270/402; B60T 2270/404; B60T 2270/406; B60T 2270/413

(57) ABSTRACT

A method is for operating a control unit for a parking brake system having a parking brake and a first and a second microcontroller for controlling the parking brake. The first and the second microcontroller are tested one after the other when the system is switched on. Nominal operation of the system is started after the test is ended. The method includes activating the second microcontroller to control the parking brake and deactivating the first microcontroller as a redundancy. When an error occurs in the second microcontroller, the system switches from nominal operation to non-nominal operation in which the first microcontroller takes over the control function of the second microcontroller. During nominal operation, operationally relevant data are transmitted from the second microcontroller to the first microcontroller so that they are available to the first microcontroller in the event of the error.

The present invention relates to a method for operating a control unit for a parking brake system. The invention further relates to a computer program product configured to carry out the method. The invention also relates to a control unit which is configured or programmed to carry out this method or computer program product. Lastly, the invention relates to a parking brake system comprising such a control unit.

A motor vehicle typically has at least one parking brake which can be used to prevent the motor vehicle from rolling away. For this purpose, the parking brake, also known as a locking brake, can be moved between a position in which the parking brake blocks at least one wheel of the motor vehicle and another position in which the parking brake releases this blocking. The motor vehicle typically comprises a control unit for moving and thus actuating the parking brake.

In the event of an error or a failure of the control unit, it is desirable to nonetheless still be able to actuate the parking brakes. It is conceivable that such control units be configured redundantly. Therefore, parking brake systems that comprise a control unit with two microcontrollers for controlling the parking brake are known. This ensures that the parking brake can still be controlled by the other microcontroller in the event of a single error in one of the two microcontrollers.

Such a system is described in DE 10 2017 222 484 A1, for example.

The difficulty here is adjusting the two microcontrollers to one another in nominal operation such that, if an error occurs in the active microcontroller, the previously inactive microcontroller can take over the function of the active microcontroller. The continuously necessary data synchronization of significant amounts of data between the two microcontrollers in nominal operation needed for this proves in practice to be very laborious and can limit the performance of the control unit with the two microcontrollers to a not inconsiderable extent, even in nominal, i.e. error-free, operation.

The object of the present invention is therefore to create an improved method for operating a control unit comprising two microcontrollers for a parking brake system which addresses the above problem.

This object is achieved by the subject matter of the independent claims. Preferred embodiments are the subject matter of the dependent claims.

The basic idea of the present invention is therefore to continuously compare only those data between the two microcontrollers, i.e. between the active and the inactive but redundant microcontroller, in a nominal operating state of the control unit that are actually operationally relevant and are thus required in the event of an error for a seamless switchover from the active microcontroller to the previously inactive, redundant microcontroller. Data that are less or not at all operationally relevant, on the other hand, are compared only when the control unit or parking brake system using this control unit is switched on, i.e. is put in operation, and optionally after the end of operation, i.e. when the control unit or the parking brake system is switched off. This makes it possible to significantly reduce the data load during the data exchange between the two microcontrollers in nominal operation of the control unit without impairing or even a smooth transition of control from the microcontroller that was active until the error occurred to the previously redundant, inactive microcontroller.

The method according to the invention is used to operate a control unit for a parking brake system comprising a parking brake, a first and a second microcontroller, a first and a second electronic circuit arrangement and a first and a second H-bridge for controlling the parking brake. According to the method, the first and the second microcontroller are tested one after the other when the system is switched on. Nominal operation of the system is started after this test is ended. This involves activating the second microcontroller to control the parking brake and deactivating the first microcontroller as a redundancy so that it does not control the servomotor. If an error occurs in the second microcontroller, the system switches from nominal operation to non-nominal operation in which the first microcontroller takes over the control function of the second microcontroller to control the parking brake. During nominal operation, operationally relevant data are continuously transmitted from the second microcontroller to the first microcontroller so that they are available to the first microcontroller in the event of an error. This counteracts the occurrence of further errors when switching control from the second microcontroller to the first microcontroller. Ideally, this completely eliminates the occurrence of such errors. The method according to the invention can be implemented as a computer program product in the control unit or in its two microcontrollers.

In a preferred embodiment of the method according to the invention, the system switches from nominal operation to non-nominal operation also if an error occurs in the second electronic circuit arrangement.

In non-nominal operation and also in the event of an error in a second electronic circuit arrangement, the first microcontroller expediently controls the first H-bridge and also the second H-bridge via a first electronic circuit arrangement of the control unit.

In nominal operation, the second microcontroller particularly preferably controls the first H-bridge and also the second H-bridge via the second electronic circuit arrangement of the control unit.

In another preferred embodiment, the test of the first microcontroller takes place chronologically before the test of the second microcontroller. This means that the second microcontroller, which is intended for nominal operation after the control unit has been switched on or initialized, is the second to be subjected to a functional test. A first electronic circuit arrangement that interacts with the first microcontroller to control the two H-bridges, which are in turn used to control the servomotor of the parking brake, can then also be subjected to a functional test. Only then is the second microcontroller which is provided for nominal operation, i.e. controls the parking brake in nominal operation after the test has been completed, subjected to a functional test. In the same way, a second electronic circuit arrangement that interacts with the second microcontroller to control the two H-bridges, which are used to control the servomotor of the parking brake, can be subjected to a functional test.

During nominal operation, data that are not operationally relevant are particularly preferably not transmitted continuously or cyclically from the second to the first microcontroller. This makes it possible to at least counteract overloading of the data connection between the two microcontrollers during operation. Ideally, this completely eliminates such overloading.

According to an advantageous further development of the method according to the invention, non-operationally relevant data, i.e. data that are not transmitted between the two microcontrollers during nominal operation, are transmitted from the second microcontroller controlling the parking brake to the first microcontroller after the end of operation. This ensures that the two microcontrollers are synchronized the next time the parking brake system is switched on.

To avoid data loss or synchronization problems in the course of switching off, the operationally relevant data can particularly preferably also be transmitted from the microcontroller controlling the parking brake to the other microcontroller after the end of operation.

The invention further relates to a computer program product which contains instructions that can be read by a control unit such that the control unit carries out the above presented method according to the invention when it executes the computer program product.

The present invention also relates to a control unit for a parking brake system of a motor vehicle. The control unit comprises a first and a second H-bridge for selectively controlling a servomotor of the parking brake system as well as a first electronic circuit arrangement for controlling the two H-bridges and a second electronic circuit arrangement for controlling the two H-bridges. The control unit also comprises a first microcontroller for controlling the first circuit arrangement and a second microcontroller for controlling the second circuit arrangement. The microcontrollers are connected to one another such that they transmit data or are able to transmit data. According to the invention, the control unit is configured and/or programmed to carry out above presented method according to the invention such that the above-discussed advantages of the method according to the invention apply likewise to the control unit according to the method according to the invention can be implemented as a computer program product in control unit according to the invention or in its two microcontrollers.

The invention also relates to a parking brake system for a motor vehicle. The parking brake system according to the invention comprises a parking brake with an actuator for blocking a wheel of the motor vehicle and a servomotor for adjusting the actuator. The parking brake system further comprises a control unit according to the invention for controlling the servomotor such that the above-discussed advantages of the method according to the invention also transfer to the parking brake system according to the invention.

Further important features and advantages of the invention will emerge from the subclaims, from the drawings and from the associated description of the figures with reference to the drawings.

It goes without saying that the aforementioned features and the features yet to be explained in the following can be used not only in the respectively specified combination, but also in other combinations or on their own, without leaving the scope of the present invention.

Preferred embodiment examples of the invention are shown in the drawings and will be explained in more detail in the following description, wherein same reference signs refer to same or similar or functionally same components.

Schematically, the figures show:

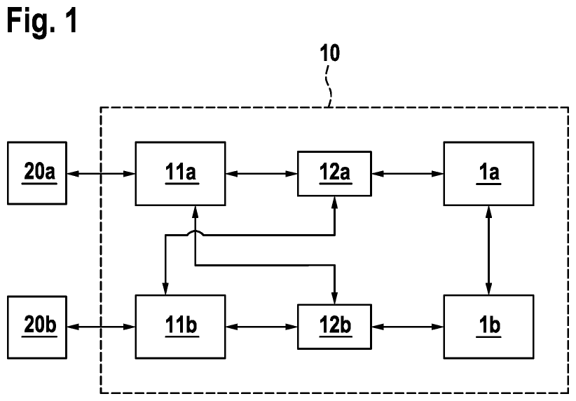

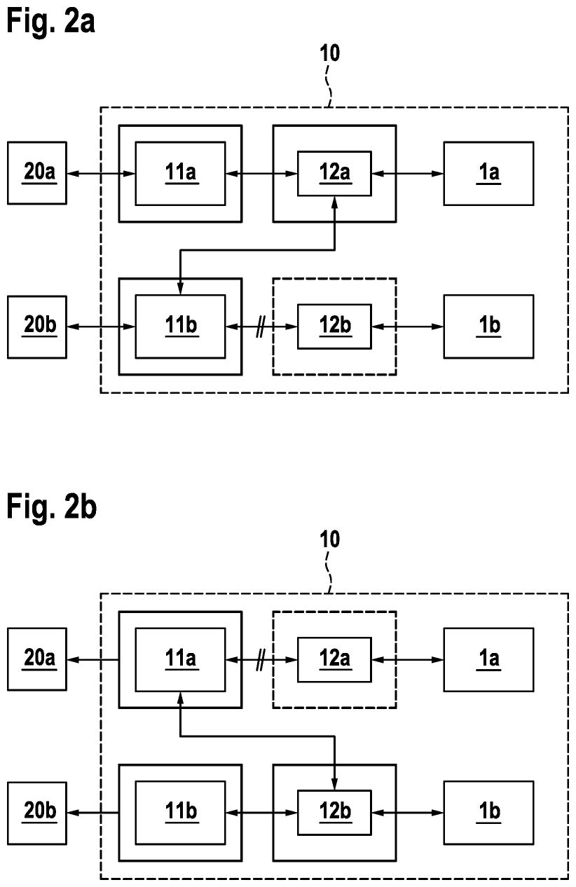

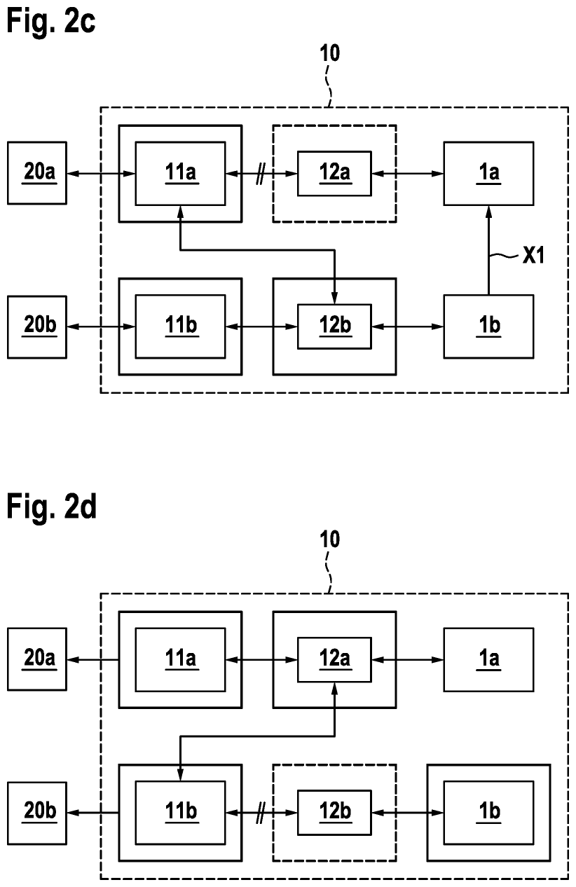

FIG. 1 an illustration showing an example of the structure of the control unit according to the invention, FIG. 2a-d diagrams explaining the method according to the invention using examples.

FIG. 1 shows a schematic illustration of an example of the structure of a control unit 10 for a parking brake system of a motor vehicle (not shown). The parking brake system includes a parking brake comprising two actuators (not shown) for blocking a wheel of the motor vehicle and two servomotors 20a, 20b for adjusting the two actuators. The servomotors 20a, 20b can be controlled and thus adjusted by means of the control unit 10, which in turn results in an adjustment of the actuators (not shown) that are drive-connected to the servomotors 20a, 20b. The control unit 10 comprises a first and a second H-bridge 11a, 11b for selectively controlling the two servomotors 20a, 20b. The two H-bridges 11a, 11b can comprise power amplifiers in a known manner for controllably driving the servomotors 20a, 20b.

The control unit 10 according to FIG. 1 further comprises a first electronic circuit arrangement 12a for controlling the two H-bridges 11a, 11b and a second electronic circuit arrangement 12b for controlling the two H-bridges 11a, 11b. The control unit 10 also comprises first microcontroller la for controlling the first circuit arrangement 12a and a second microcontroller 1b for controlling the second circuit arrangement 12b.

The method according to the invention can be carried out in the control unit 10, which is explained in the following with reference to the flowchart of FIGS. 2a-2d.

According to the method, the first and the second microcontrollers 1a, 1b are tested one after the other in a measure a) when the control unit 10 is switched on. In the example, the test of the first microcontroller la takes place chronologically before the test of the second microcontroller 1b. In the course of testing the two microcontrollers 1a, 1b, the two H-bridges 11a, 11b of the control unit 10 are tested as well.

As shown in FIG. 2a, this involves first activating the first circuit arrangement 12a and deactivating the second circuit arrangement 12b. In this configuration, both H-bridges 11a, 11b are tested by means of the first microcontroller 1a, which controls the two H-bridges 11a, 11b via the first circuit arrangement 12a.

Then, as shown in FIG. 2b, the first circuit arrangement 12a is deactivated and the second circuit arrangement 12b is activated. In this configuration, both H-bridges 11a, 11b are tested by means of the second microcontroller 1b, which controls the two H-bridges 11a, 11b via the second circuit arrangement 12b and tests them in this way.

Subsequently, a nominal operation of the control unit 10 shown in FIG. 2c is started. In the course of nominal operation, in a measure b) of the method, the second microcontroller 1b remains activated to control the two servomotors 20a, 20b, whereas the first microcontroller 1a remains inactive with respect to the control of the two servomotors 20a, 20b as a redundant unit. The second microcontroller 1b controls the two H-bridges 11a, 11b via the second circuit arrangement 12b.

During nominal operation, operationally relevant data that have been updated in the memory of the second microcontroller 1b are transmitted from the second microcontroller 1b to the first microcontroller 1a after the update is completed (see arrow X1 in FIG. 2c), so that they are available to the first microcontroller la in the event of an error. Data that are not relevant for the operation of the control unit 10 or the parking brake, on the other hand, are not transmitted from the second microcontroller 1b to the first microcontroller la during nominal operation. There is therefore no creation of an unnecessary data load during data transmission between the two microcontrollers 1a, 1b.

If an error occurs in the second microcontroller 1b, as shown in FIG. 2d in a measure c) of the method, the system switches from nominal operation to non-nominal operation in which first microcontroller la takes over the control function of the second microcontroller 1b. Due to synchronization of operationally relevant data between the two microcontrollers 1a, 1b during nominal operation, this transition is possible without further data exchange. The first microcontroller la now controls the two H-bridges 11a, 11b via the two circuit arrangements 12b. This ensures that, despite the malfunction that has occurred in the second microcontroller the control of the servomotor 10 of the parking brake continues—ideally without being noticed the user of the control unit 10.

In the typically occurring scenario that there is no error in the second microcontroller 1b during nominal operation, so that there is no need to switch to non-nominal operation, non-operationally relevant data can be transmitted from the second microcontroller 1b to the first microcontroller la after the end of operation of the control unit 10 or the parking brake system in a measure d).

After the end of operation, to be on the safe side, operationally relevant data, preferably all of the operationally relevant data, can also be transmitted again from the second microcontroller 1b controlling the servomotors 20a, 20b to the first microcontroller 1a.

In a variant of the method according to the invention, the system switches from nominal operation to non-nominal operation also if an error occurs in the second electronic circuit arrangement 12b.

In non-nominal operation and also in the event of an error in a second electronic circuit arrangement 12b, the first microcontroller 1a expediently controls the first H-bridge 11a and also the second H-bridge 11b of a first electronic circuit arrangement 12a of the control unit 10.

1. A method for operating a control unit for a parking brake system comprising a parking brake, a first microcontroller, a second microcontroller, a first electronic circuit arrangement, a second electronic circuit arrangement, and a first H-bridge and a second H-bridge configured to control a first servomotor and a second servomotor of the parking brake, the method comprising:
testing the first microcontroller and the second microcontroller one after the other when the control unit is switched on;
starting nominal operation of the control unit after the test is ended by activating the second microcontroller to control the first servomotor and the second servomotor and deactivating the first microcontroller as a redundancy;
when an error occurs in the second microcontroller, switching from the nominal operation to a non-nominal operation in which the first microcontroller takes over control of the first servomotor and the second servomotor from the second microcontroller; and
transmitting during the nominal operation, only operationally relevant data from the second microcontroller to the first microcontroller so that the transmitted data are available to the first microcontroller when the error occurs.

2. The method according to claim 1, further comprising:
switching, using the parking brake system, from the nominal operation to the non-nominal operation when an error occurs in the second electronic circuit arrangement.

3. The method according to claim 2, wherein, in the non-nominal operation and when the error occurs in the second electronic circuit arrangement, the first microcontroller controls the first H-bridge and the second H-bridge using the first electronic circuit arrangement of the control unit.

4. The method according to claim 1, wherein, in the nominal operation, the second microcontroller controls the first H-bridge and the second H-bridge using the second electronic circuit arrangement of the control unit.

5. The method according to claim 1, wherein the test of the first microcontroller takes place chronologically before the test of the second microcontroller.

6. The method according to claim 1, wherein the first electronic circuit arrangement is switched to inactive after the test has been carried out so that the first electronic circuit arrangement does not control the first servomotor and the second servomotor.

7. The method according to claim 1, wherein, during the nominal operation of the control unit, non-operationally relevant data are not transmitted from the microcontroller controlling the first servomotor and the second servomotor of the parking brake to the other microcontroller.

8. The method according to claim 1, wherein, after an end of the nominal operation of the control unit non-operationally relevant data are transmitted from the microcontroller controlling the first servomotor and the second servomotor of the parking brake to the other microcontroller.

9. The method according to claim 1, wherein, after an end of the nominal operation of the control unit, all operationally relevant data are transmitted from the microcontroller controlling the parking brake to the other microcontroller.

10. The method according to claim 1, wherein a computer program product, contains instructions that can be read by a control unit such that the control unit carries out the method when the control unit executes the computer program product.

11. A control unit for a parking brake system of a motor vehicle, comprising:
a first H-bridge and a second H-bridge configured to selectively control a first servomotor and a second servomotor of the parking brake system;
a first electronic circuit arrangement configured to control the first H-bridge;
a second electronic circuit arrangement configured to control the second H-bridge;
a first microcontroller configured to control the first circuit arrangement; and
a second microcontroller configured to control the second circuit arrangement,
wherein the first microcontroller and the second microcontroller are connected to one another such that the first microcontroller and the second microcontroller transmit data or are able to transmit data, and
wherein the control unit is configured to carry out the method according to claim 1.

12. (canceled)

13. A parking brake system for a motor vehicle, comprising:
a parking brake including at least one actuator configured to block a wheel of the motor vehicle and at least one servomotor configured to adjust the at least one actuator; and
a control unit according to claim 11 configured to control the at least one servomotor.
